(19) United States
(12) Patent Application Publication
(10) Pub. No.: US 2026/0370418 A1
(43) Pub. Date: Nov. 19, 2026

(54) SOUNDING REFERENCE SIGNAL TRANSMISSION TECHNIQUES IN THREE-PORT UPLINK TRANSMISSION

(71) Applicant: ZTE Corporation, Shenzhen (CN)

(72) Inventors: Ke YAO, Shenzhen (CN); Yang ZHANG, Shenzhen (CN); Bo GAO, Shenzhen (CN); Guangyu JIANG, Shenzhen (CN)

(21) Appl. No.: 19/705,710

(22) Filed: Jun. 11, 2026

Related U.S. Application Data
(63) Continuation of application No. PCT/CN2023/139305, filed on Dec. 15, 2023.

(51) Int. Cl. H04L 5/00

(52) U.S. Cl. CPC H04L 5/0051

(57) ABSTRACT

Some embodiments of the present disclosure are related to configurations of sounding reference signal (SRS) to support three-port uplink transmission. An example wireless communication method includes: receiving, at a user equipment (UE), a sounding reference signal (SRS) configuration from a base station (BS), indicating an SRS resource with three ports; determining, by the UE, respective cyclic shifts (CSs) for the three ports of the SRS resource; and transmitting, by the UE to the BS, an SRS transmission according to the respective CSs for the three ports of the SRS resource.

### CROSS-REFERENCE TO RELATED APPLICATION(S)

This application is a continuation of International Patent Application No. PCT/CN2023/139305, filed on Dec. 15, 2023. The entire contents of the before-mentioned patent application is incorporated by reference as part of the disclosure of this application.

### TECHNICAL FIELD

This disclosure is directed generally to digital wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs. Various techniques, including new ways to provide higher quality of service, longer battery life, and improved performance are being discussed.

### SUMMARY

Techniques are disclosed for configuring SRS transmission to support three-port uplink transmission. Herein, “support” may mean, for example, to perform a PUSCH transmission using exactly the same ports used in this SRS transmission, or a sub-group of the ports used in the SRS transmission. Herein, a Tx may correspond to a port; a Tx or port is used interchangeable with a Tx port, an antenna port, a transmit antenna, or a transmit antenna port.

In one aspect, a method of wireless communication performed by a wireless device (e.g., a user equipment (UE)) is disclosed. The method includes: receiving, at a user equipment (UE), a sounding reference signal (SRS) configuration from a base station (BS), indicating an SRS resource with three ports; determining, by the UE, respective cyclic shifts (CSs) for the three ports of the SRS resource; and transmitting, by the UE to the BS, an SRS transmission according to the respective CSs for the three ports of the SRS resource.

In another aspect, a method of wireless communication performed by a network device (e.g., a base station (BS)) is disclosed. The method includes: transmitting, from a base station (BS) to a user equipment (UE), a sounding reference signal (SRS) configuration indicating an SRS resource with three ports; and receiving, by the BS, an SRS transmission according to the SRS configuration.

In another aspect, a method of wireless communication performed by a wireless device (e.g., a UE) is disclosed. The method includes: receiving, at a user equipment (UE), a sounding reference signal (SRS) configuration from a base station (BS), indicating one or more SRS resources in one or more SRS resource set with usage of antenna switching, and indicating one configuration of 3T3R, 3T4R, 3T6R, or 3T8R; and transmitting, by the UE to the BS, an SRS transmission according to the SRS configuration.

In another aspect, a method of wireless communication performed by a network device (e.g., a BS) is disclosed. The method includes: transmitting, from a base station (BS) to a user equipment (UE), a sounding reference signal (SRS) configuration indicating one or more SRS resources in one or more SRS resource set with usage of antenna switching, and indicating one configuration of 3T3R, 3T4R, 3T6R, or 3T8R; and receiving, by the BS, an SRS transmission according to the SRS resource configuration.

In another aspect, a method of wireless communication performed by a wireless device (e.g., a UE) is disclosed. The method includes: receiving, by a user equipment (UE) from a base station (BS), a sounding reference signal (SRS) configuration; determining, by the UE according to the SRS configuration, a first SRS resource with M ports and a second SRS resource with N ports, wherein the first SRS resource and the second SRS resource correspond to different transmitting time domain resources; and transmitting, by the UE to the BS, an SRS transmission on ports of the first SRS resource and the second SRS resource with a same transmit power for each of the ports, in which: N is a positive integer, and M is a positive integer that is greater than N.

In another aspect, a method of wireless communication performed by a network device (e.g., a BS) is disclosed. The method includes: transmitting, by a base station (BS) to a user equipment (UE), a sounding reference signal (SRS) configuration; in which: the SRS configuration is used by the UE to determine a first SRS resource with M ports and a second SRS resource with N ports, and the first SRS resource and the second SRS resource correspond to different transmitting time domain resources; and receiving, by the BS, an SRS transmission on ports of the first SRS resource and the second SRS resource transmitted with a same transmit power for each of the ports, in which: N is a positive integer, M is a positive integer that is greater than N, and the same transmit power for each of the ports is determined according to the transmit power of one port of the first SRS resource.

In yet another exemplary aspect, the above-described methods are embodied in the form of processor-executable code and stored in one or more non-transitory computer-readable storage media. The code included in the computer readable storage media when executed by one or more processors, causes the one or more processors to implement the methods described in this patent document.

In yet another exemplary embodiment, a wireless communication device that is configured or operable to perform the above-described methods is disclosed. The wireless communication device may be a wireless device (e.g., a user equipment (UE)), or a network device (e.g., a base station (BS)).

The above and other aspects and their implementations are described in greater detail in the drawings, the descriptions, and the claims.

### BRIEF DESCRIPTION OF THE DRAWING

FIG. 1 shows an example of a wireless communication system in accordance with some embodiments of the disclosed technology.

FIG. 2 is a block diagram representation of a portion of an apparatus in accordance with some embodiments of the disclosed technology.

FIGS. 3A-6 illustrates examples of antenna switching arrangements in accordance with some embodiments of the disclosed technology.

FIGS. 7-12 are flowcharts of example methods of wireless communication in accordance with some embodiments of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

The new radio (NR) technology of fifth generation (5G) mobile communication systems is continuously improved to provide higher quality wireless communication. Multiple Input Multiple Output (MIMO) is one of key features in 5G NR. Legacy technique for MIMO has already supported 2, 4, and 8 transmit (Tx) ports for UL transmission.

Generally, if more than one transmit antenna (1Tx) is equipped for a user equipment (UE), 2Tx, 4Tx or 8Tx UE is considered, so codebook for physical uplink shared channel (PUSCH) is specified as 2 ports, 4 ports, or 8 ports for such requirements. However, in reality, UE is commonly equipped with 1Tx or 2Tx, and 4Tx UE is rare due to cost and/or complexity. As a compromise, 3Tx is considered for UE configuration as a next step of 2Tx UE. To support 3Tx UE, 3Tx UL transmission schemes need be designed, e.g., 3Tx (port) PUSCH transmission, and/or 3Tx (port) sounding reference signals (SRS).

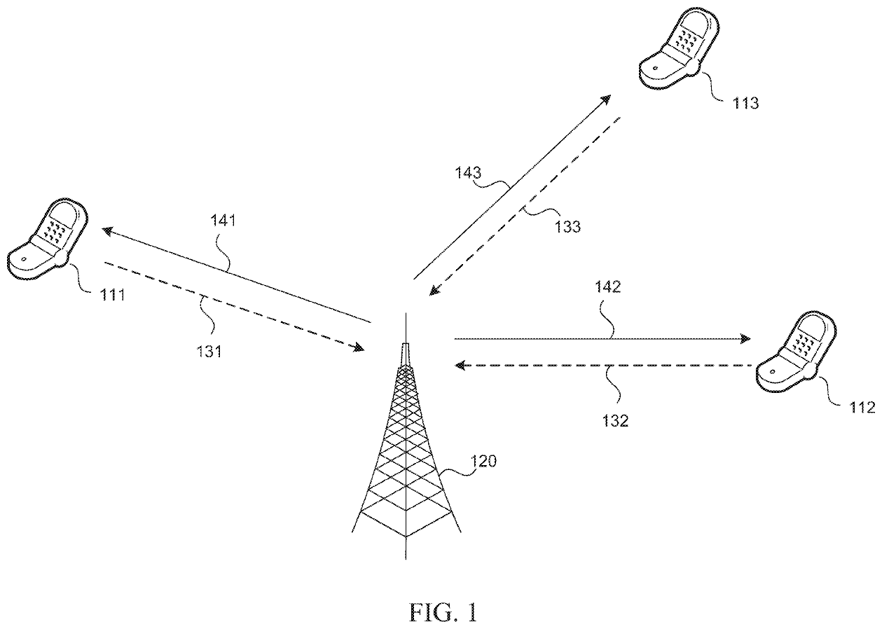

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include downlink control information (DCI) or high layer signaling or downlink information. The UE may be, for example, a smartphone, a tablet, a mobile computer, a machine to machine (M2M) device, a terminal, a mobile device, an Internet of Things (IoT) device, and so on.

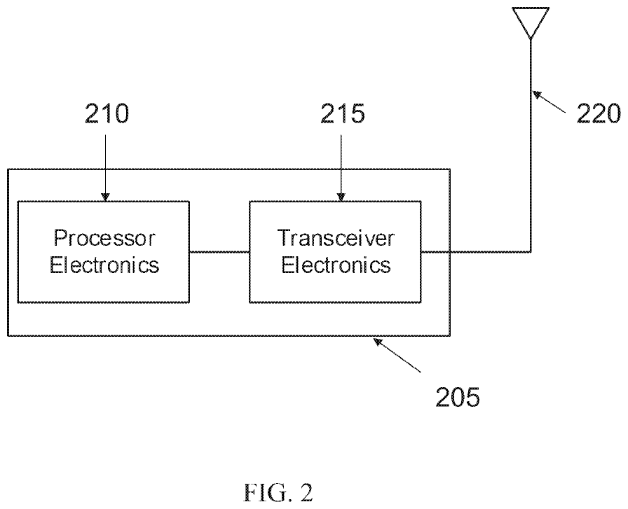

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

SRS in wireless communication is used in multiple aspects for efficient network performance, especially in LTE (Long-Term Evolution) and 5G networks. Channel sounding may involve sending a known signal from a transmitter (e.g., a UE), which is then analyzed at the receiver (e.g., a BS) to gain information about the wireless channel. This process may help in understanding various characteristics of the communication channel, such as path loss, fading, delay spread, Doppler spread, etc. SRS may enable the network to adaptively optimize data transmission for efficiency, speed, and reliability.

Merely by way of example, to perform an uplink transmission, a user equipment (UE) transmits SRS to a base station. Upon receiving the SRS, the base station may perform channel estimation. This process involves analyzing the SRS to understand the channel conditions, such as path loss, fading, and interference patterns. The channel estimation may give the base station a detailed understanding of how a signal propagates from the UE to the base station over the uplink channel. Based on the channel estimation, the base station may determine information including, e.g., ports to be used for a subsequent uplink transmission (e.g., a PUSCH transmission), a precoding matrix, etc. The ports to be used, including the number (or count) of the ports, may be specified in SRS resource indicator (SRI) information. This matrix may be designed to optimize the transmission for the specific channel conditions encountered by the SRS. The precoding matrix may adjust the amplitude and phase of an uplink signal before transmission, thereby improving signal reception under given channel conditions. The precoding matrix (or the parameters/instructions based on it) may be then conveyed back to the UE. This feedback can be explicit, where the exact precoding matrix is sent back, or implicit, where the UE is instructed on how to adjust its transmission parameters based on the matrix. The UE may apply this precoding matrix to the data signal and transmit it via the ports indicated by the SRI information on the channel. Accordingly, the channel sounding by SRS may allow effective adjustment of the uplink signal to counteract the impairments and distortions identified in the uplink channel, thereby enhancing the effectiveness of the signal transmission. This process is dynamic and adaptive. As the channel conditions change, due to factors like UE mobility or varying interference, the base station may update the precoding matrix based on new SRS measurements and feeds this information back to the UE.

For effective support of a three-port uplink transmission (e.g., PUSCH transmission), an SRS resource configuration with at least three ports is needed. This involves setting up cyclic shifts for one or more SRS resources configured to handling at least three ports, antenna switching in the context of three-port SRS configuration, among others. Details are provided as follows.

### Embodiment 1: SRS Resource(s) with Three Ports

In TS38.211, an SRS resource is specified as below.

An SRS resource is configured by a UE according to an SRS configuration sent by a network. To support a three-port uplink transmission (e.g., a three-port PUSCH transmission), the SRS resource is configured with at least three ports. The parameter

$${n}_{SRS}^{cs , max} ,$$

standing for a maximum number (or count) of cyclic shifts in an SRS configuration, is determined according to a higher layer parameter as in Table 6.4.1.4.2-1 in TS38.211. If the parameter

$${n}_{SRS}^{cs , max}$$

determined as 8, and if the number (or count) of antenna ports involved in the SRS transmission

$${N}_{ap}^{ARS}$$

is 3 for 3-port SRS

$${n}_{SRS}^{cs , max} / {N}_{ap}^{SRS}$$

is not an integer, i.e., eight CS resources cannot be evenly allocated to three ports. That means

$${n}_{SRS}^{cs , i}$$

cannot be determined according the current specification.

### Solution 1

A restriction may be introduced as follows. A UE does not expect (or is not expected) to be configured with a comb parameter, the comb number (or count) K_{TC}=2, or a maximum number (or count) of CS resources

$${n}_{SRS}^{cs , max} = 8 ,$$

for an SRS resource configured with three ports. Similarly, a network is not expected to configure K_{TC}=2, or

$${n}_{SRS}^{cs , max} = 8 ,$$

for an SKS resource configured with three ports. Therefore, according to Table 6.4.1.4.2-1, the available parameters for selection for the comb number (or count) K_{TC} or the maximum number (or count) of CS resources

$${n}_{SRS}^{cs , max}$$

include K_{TC}=4 and

$${n}_{SRS}^{cs , max} = 12 ; {K}_{TC} = 8 and {n}_{SRS}^{cs , max} = 6 ,$$

such that the CS resources may be evenly allocated to the three ports.

Accordingly, the cyclic shift αᵢ for antenna port pᵢ may be given as

$${α}_{i} = 2 π \frac{{n}_{SRS}^{cs , i}}{{n}_{SRS}^{cs , max}} , \qquad ( 1 )$$

in which

$${n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max} , \qquad ( 2 )$$

because

$${N}_{ap}^{SRS} = 3 , not 4.$$

In equation (2),

$${n}_{SRS}^{cs}$$

may relate to a reference position (e.g., a starting position) among the available CS resources on the basis of which the cyclic shifts for respective ports are assigned

$${n}_{SRS}^{cs}$$

may be an integer between 0 and

$$( {n}_{SRS}^{cs , max} - 1 ) .$$

Table 1 below shows exemplary cyclic shift configuration parameters for three-port SRS resource(s).

TABLE 1

| K_{TC} | 4 | 8 |
|---|---|---|
| ${n}_{SRS}^{cs , max}$ | 12 | 6 |
| ${n}_{S R S}^{c s}$ | Any one of 0, 1, 2, ... , 11 | Any one of 0, 1, 2, ... , 5 |
| ${n}_{SRS}^{cs , 0}$ | ${n}_{SRS}^{cs}$ | ${n}_{SRS}^{cs}$ |
| ${n}_{SRS}^{cs , 1}$ | $( {n}_{SRS}^{cs} + 4 ) mod 12$ | $( {n}_{SRS}^{cs} + 2 ) mod 6$ |
| ${n}_{SRS}^{cs , 2}$ | $( {n}_{SRS}^{cs} + 8 ) mod 12$ | $( {n}_{SRS}^{cs} + 4 ) mod 6$ |

### Solution 2

For an SRS resource configured with three ports,

$$i . e . , {N}_{ap}^{SRS} = 3 ,$$

CS (cyclic shift) for port i (i.e., pᵢ) can be determined by rounding, e.g., rounding up or down, a ratio of the maximum number (or count) of cyclic shift resources (or referred to as candidate cyclic shifts) to the number (or count) of the ports.

$$\frac{{n}_{SRS}^{cs , max}}{{N}_{ap}^{SRS}} .$$

For example,

$${n}_{SRS}^{cs , i} = ( {n}_{SRS}^{cs} + ⌈ \frac{{n}_{SRS}^{cs , max}}{{N}_{ap}^{SRS}} ⌉ ( {p}_{i} - 1000 ) ) mod {n}_{SRS}^{cs , max} , if {N}_{ap}^{SRS} = 3 and {n}_{SRS}^{cs , max} = 8. \qquad ( 3 )$$

Table 2 below shows exemplary cyclic shift configuration parameters for three-port SRS resource(s). According to equation 3,

$${n}_{SRS}^{cs} , ( {n}_{SRS}^{cs} + 3 )$$

mod 8 and

$$( {n}_{SRS}^{cs} + 6 )$$

mod 8 can correspond to the 3 ports, the CS offset between the port 0 to port 1 is 3, and the CS offset between port 1 and 2 is 3 too. Alternatively, as shown table 2, the CS offset between the port 0 to port 1 can be 3 (or 2), and the CS offset between port 1 and 2 can be 2 (or 3).

TABLE 2

| K_{TC} | 2 | | |
|---|---|---|---|
| ${n}_{SRS}^{cs , max}$ | 8 | | |
| ${n}_{SRS}^{cs}$ | Any one of 0, 1, 2, ... , 7 | | |
| ${n}_{SRS}^{cs , 0}$ | ${n}_{SRS}^{cs}$ | | |
| ${n}_{SRS}^{cs , 1}$ | $( {n}_{SRS}^{cs} + 3 ) mod 8$ | $( {n}_{SRS}^{cs} + 3 ) mod 8$ | $( {n}_{SRS}^{cs} + 2 ) mod 8$ |
| ${n}_{SRS}^{cs , 2}$ | $( {n}_{SRS}^{cs} + 6 ) mod 8$ | $( {n}_{SRS}^{cs} + 5 ) mod 8$ | $( {n}_{SRS}^{cs} + 5 ) mod 8$ |

### Embodiment 2: Three-Port SRS Antenna Switching

For a three-port UE, SRS with usage of ‘antennaSwitching’ can support 3T3R (can also be referred as 3T=3R), 3T6R, 3T4R, or 3T8R, in which xTyR indicates that there are x transmitter antennas (ports) and y receiver antennas (ports), and x or y may be a positive integer number.

The UE may report capability of at least one configuration or switching arrangement of 3T3R, 3T6R, 3T4R, or 3T8R, to a network (e.g., to a network device). The three-port UE may be configured to transmit at least one SRS resource or at least one SRS resource set with usage of ‘antennaSwitching’, with the configuration or switching arrangement of 3T3R, 3T6R, 3T4R, or 3T8R.

### Case 1: 3T3R

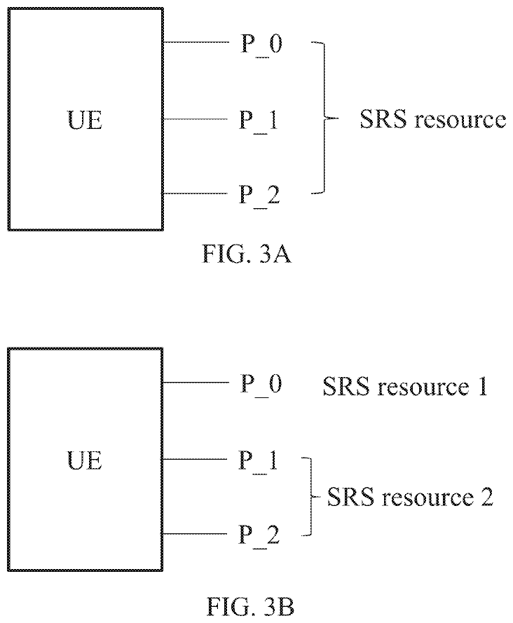

In some embodiments, for the switching arrangement of 3T3R for a UE, one SRS resource or one SRS resource set with one SRS resource can be configured, where the number (or count) of SRS ports for the SRS resource (ports for transmitting an SRS resource) is equal to three such that the SRS resource may traverse the three transmit ports for the three receive ports under the switching arrangement of 3T3R of the UE as illustrated in FIG. 3A.

In some embodiments, for the switching arrangement of 3T3R, up to two SRS resources or up to two SRS resource sets each with one SRS resource can be configured, where the number of SRS ports for each SRS resource is equal to 1 or 2. The two SRS resources can be referred to as an SRS resources pair, or an SRS resource group. When combined, the two SRS resources may support a three-port SRS transmission. One SRS resource of the SRS resource pair is configured with one SRS port, and the other SRS resource is configured with two SRS ports. For example, the SRS resource in a first SRS resource set is associated with one SRS port, and the SRS resource in a second SRS resource set is associated with two SRS ports. As another example, the SRS resource in a first SRS resource set is associated with two SRS ports, and the SRS resource in aa second SRS resource set is associated with one SRS port. As a further example, the two SRS resources may belong to a same SRS resource set, and are configured with one SRS port and two SRS ports, respectively.

The two SRS resources share no same UE antenna ports such that the SRS resources may traverse the three transmit ports for the three receive ports under the switching arrangement of 3T3R of the UE. For example, a first SRS resource (in an SRS resource set, e.g., a first SRS resource set) is associated with a group of UE antenna port(s) different from (not overlapping) the SRS port(s) of a second SRS resource (in an SRS resource set that is the first SRS resource set or a second SRS resource set that is different from the first SRS resource set), as illustrated in FIG. 3B.

In some embodiments, the two SRS resources can be transmitted in (one) same symbols to realize 3Tx (3-port) SRS transmission. The two SRS resources can be transmitted in a same frequency domain resource, e.g., a same resource block (RB) set.

In some embodiments, the two SRS resources can be transmitted in different symbols to realize 3Tx (3-port) SRS transmission. The two SRS resources can be transmitted in same frequency domain resource, e.g., a same RB set.

### Case 2: 3T4R

In some embodiments, for the switching arrangement of 3T4R for a UE, two SRS resources can be configured, where the number (or count) of SRS ports for each SRS resource is equal to three. The two SRS resources may belong to a same SRS resource set, or two SRS resource sets.

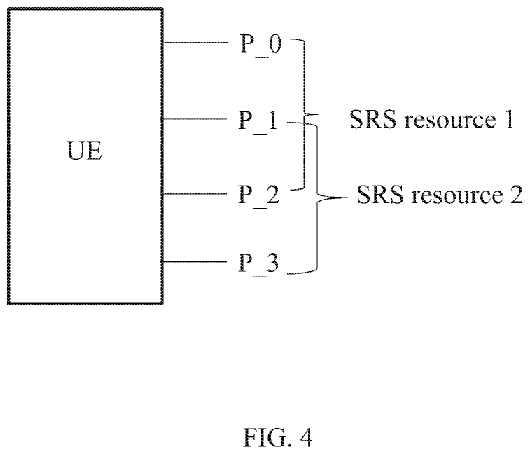

One of the two SRS resources may be associated with a group of UE antenna port(s) partially different from (partially overlapping) the other of the two SRS resources such that the two SRS resources may traverse the three transmit ports for the four receive ports under the switching arrangement of 3T4R of the UE. Merely by way of example, the UE has four antenna ports, ports 0 through 3; one of the two SRS resources is associated with UE antenna ports 0, 1, and 2, and the other of the two SRS resources is associated with UE antenna port 3 (the UE antenna port for port 3 being different from any one of port 0, 1, 2) and two ports from UE antenna ports 0, 1, and 2 as illustrated in FIG. 4, such that the two SRS resources traverse the three transmit ports for the four receive ports under the switching arrangement of 3T4R of the UE. The two SRS resources may be transmitted in different symbols or in different slots (each slot including a plurality of symbols). The two SRS resources may be transmitted in a same frequency domain resource.

In some embodiments, at least one of the two SRS resources (each configured with three ports) may be replaced by an SRS resource pair with a first SRS resource one port and a second SRS resource configured with two ports, similar to the illustration of FIG. 3B.

In some embodiment, for 3T4R, two SRS resources in one SRS resource set, or two SRS resource sets each with one SRS resource can be configured, where the number of SRS ports for one SRS resource is equal to 3, and the number of SRS ports for another SRS resource is equal to 1. The SRS resource of the first SRS resource set or the first SRS resource may be associated with different UE antenna port(s) from the SRS port(s) of the SRS resource in the second SRS resource set, or the second SRS resource. E.g., the first SRS resource set or the first SRS resource is associated with UE antenna ports 0, 1, 2, and the second SRS resource set of the second SRS resource is associated with UE antenna port 3. The two SRS resources are transmitted in different symbols or in different slots. The two SRS resources may be transmitted in the same frequency domain resources.

One SRS resource configured with 3 ports can be also replaced by an SRS resource pair with one SRS resource configured with 2 ports and one SRS resource configured with 1 port. Then the second SRS resource can be configured with a same port of the one SRS resource with 1 port. E.g., 3 Tx ports are combined by SRS resource 1 (with 2 ports, such as port 0, 1) and SRS resources 2 (with 1 port, such as port 2), then the 3T4R can be realized as: the first SRS resource set or the first SRS resource is associated with UE antenna ports 0, 1, 2 can be realized by a pair of SRS resources (2 ports+1 port), and the second SRS resource set of the second SRS resource is associated with UE antenna port 3, and port 3 can correspond to UE Tx antenna port 2. In other words, UE Tx antenna port 2 can be used twice for different Rx antenna ports.

Tables 1-3 illustrate exemplary SRS configurations for 3T4R.

TABLE 1
3Tx for 3T4R Configuration

| | SRS resource 0 | SRS resource 1 |
|---|---|---|
| Case 1 | Rx port: 0, 1, 2 | Rx port: 3 |
| | Tx port: 0, 1, 2 | Tx port: one of (0, 1, 2) |
| Case 2 | Rx port: 0, 1, 2 | Rx port: 3, and two of (0~2) |
| | Tx port: 0, 1, 2 | Tx port: 0, 1, 2 |
| Case 3 | Rx port: 0, 1, 2 | Rx port: 3, and 1, 2 |
| | Tx port: 0, 1, 2 | Tx port: 0, 1, 2 |

TABLE 2
3Tx being realized by 2 + 1 ports

| | SRS resource pair 0: SRS | SRS resource pair 1: SRS |
|---|---|---|
| | resource 0_0 (2 ports), | resource 1_0 (2 ports), |
| | SRS resource 0_1 (1 port) | SRS resource 1_1 (1 port |
| Case 2 | Rx port: (0, 1), (2) | Rx port: (0, 1), (3) |
| | Tx port: (0, 1), (2) | Tx port: (0, 1), (2) |

TABLE 3
3Tx being realized by 2 + 1 ports

| | SRS resource pair 0: SRS | |
|---|---|---|
| | resource 0_0 (2 ports), | |
| | SRS resource 0_1 (1 port) | SRS resource 1: (1 port) |
| Case 1 | Rx port: (0, 1), (2) | Rx port: 3 |
| | Tx port: (0, 1), (2) | Tx port: one of (0, 1, 2) |

Note that the brackets in the tables indicate relation between ports and resource, e.g., (0, 1), (2) means port 0 and 1 belong to one SRS resource, port 2 belongs to another SRS resource.

### Case 3: 3T6R

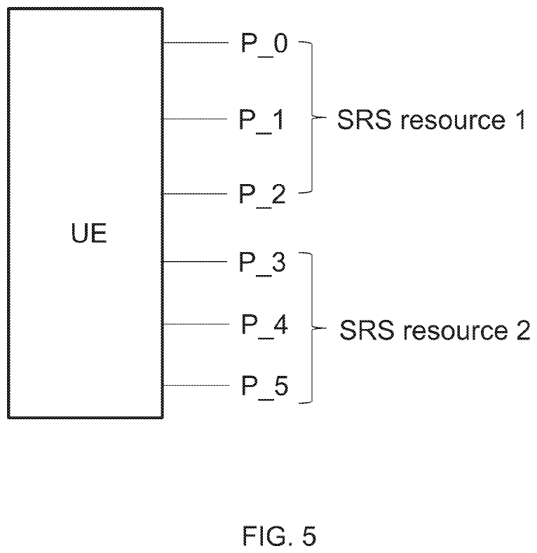

In some embodiments, for the switching arrangement of 3T6R for a UE, two SRS resources can be configured, where the number (or count) of SRS ports for each SRS resource is equal to three. The two SRS resources may belong to a same SRS resource set or different SRS resource sets. One of the two SRS resources may be associated with a group of UE antenna port(s) different from (not overlapping) the other of the two SRS resources as illustrated in FIG. 5 such that the two SRS resources may traverse the three transmit ports for the six receive ports under the switching arrangement of 3T6R of the UE. The two SRS resources are transmitted in different symbols or in different slots. The two SRS resources are transmitted in the same frequency domain resources.

In some embodiments, for the switching arrangement of 3T6R for a UE, two SRS resource pairs can be configured, where the number (or count) of SRS ports for each SRS resource pair is equal to three. For example, an SRS resource pair (similar to the illustration of FIG. 3B) includes a first SRS resource configured with one port and a second SRS resource configured with two ports. The two SRS resource pairs may belong to a same SRS resource set, or two SRS resource sets. One of the two SRS resource pairs may be associated with a group of UE antenna port(s) different from (not overlapping) the other of the two SRS resource pairs such that the two SRS resource pairs may traverse the three transmit ports for the six receive ports under the switching arrangement of 3T6R of the UE. The two SRS resource pairs may be transmitted in different symbols or in different slots. The two SRS resources in an SRS resource pair may be transmitted in a same frequency domain resource. The two SRS resources in an SRS resource pair may be transmitted in a same symbol or a same slot.

### Case 4: 3T8R

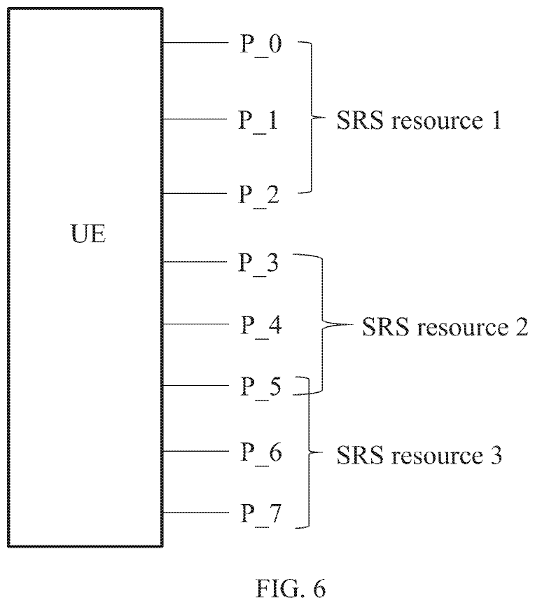

In some embodiments, for the switching arrangement of 3T8R for a UE, three SRS resources can be configured, where the number of SRS ports for each SRS resource is equal to three. The three SRS resources may belong to one SRS resource set, or three SRS resource sets each with one SRS resource. The three SRS resources may be associated with groups of UE antenna ports that are different (not overlapping) or partially different from (partially overlapping) with each other such that the three SRS resources may traverse the three transmit ports for the eight receive ports under the switching arrangement of 3T8R of the UE. For example, a first SRS resource is associated with a first group of UE antenna ports including UE antenna ports 0, 1, 2, a second SRS resource is associated with a second group of UE antenna ports including UE antenna ports 3, 4, 5, and a third SRS resource is associated with a third group of UE antenna ports including UE antenna ports 6, 7, and one port from UE antenna ports 0, 1, . . . , or 5 (e.g., UE antenna port 5) as illustrated in FIG. 6 such that the first group and the second group of UE antenna ports are different (not overlapping), that the third group may be partially different from (partially overlapping) the first group or the second group of UE antenna ports, and that the three SRS resources traverse the three transmit ports for the eight receive ports. The three SRS resources may be transmitted in different symbols or in different slots. The three SRS resources may be transmitted in a same frequency domain resource.

Any one of the three SRS resources that is configured with three ports can be also replaced by an SRS resource pair with a first SRS resource configured with one port and a second SRS resource configured with two ports, similar to the illustration of FIG. 3B.

In some embodiments, for 3T8R, three SRS resources in one SRS resource set, or three SRS resource sets each with one SRS resource can be configured, where the number of SRS ports for two resource are equal to 3, and the number of SRS ports for another SRS resource is equal to 2.

The ports of SRS resource of the first SRS resource set or the first SRS resource, the ports of SRS resource of the second SRS resource set or the second SRS resource, and the ports of SRS resource of the third SRS resource set or the third SRS resource, may be different or partially different. E.g., the first SRS resource set or the first SRS resource is associated with UE antenna ports 0, 1, 2, and the second SRS resource set or the second SRS resource is associated with UE antenna ports 3, 4, 5, and the third SRS resource set or the third SRS resource is associated with UE antenna ports 6, 7. The three SRS resources are transmitted in different symbols or in different slots. The three SRS resources are transmitted in the same frequency domain resources.

One SRS resource configured with 3 ports can be also replaced by an SRS resource pair with one SRS resource configured with 2 ports and one SRS resource configured with 1 port. Then the third SRS resource can be configured with a same port of the one SRS resource with 2 ports. E.g., 3 Tx ports are combined by SRS resource 1 (with 2 ports, such as port 0, 1) and SRS resources 2 (with 1 port, such as port 2), then the 3T8R can be realized as: the first (or second) SRS resource set or the first (or second) SRS resource is associated with UE antenna ports 0, 1, 2 can be realized by a pair of SRS resources (2 ports+1 port), and the third SRS resource set of the third SRS resource is associated with UE antenna port 6 and 7, and port 6 and 7 can correspond to UE Tx antenna port 0, 1 respectively. In other words, UE Tx antenna ports 0 and 1 can be used thrice for different Rx antenna ports 0, 1, 3, 4, 6, 7.

Tables 4-6 illustrate exemplary SRS configurations for 3T8R.

TABLE 4
3Tx for 3T8R configuration

| | SRS resource 0 | SRS resource 1 | SRS resource 2 |
|---|---|---|---|
| Case 1 | Rx port: 0, 1, 2 | Rx port: 3, 4, 5 | Rx port: 6, 7 |
| | Tx port: 0, 1, 2 | Tx port: 0, 1, 2 | Tx port: any two of (0, 1, 2) |
| Case 2 | Rx port: 0, 1, 2 | Rx port: 3, 4, 5 | Rx port: 6, 7, and |
| | | | one of (0~5) |
| | Tx port: 0, 1, 2 | Tx port: 0, 1, 2 | Tx port: 0, 1, 2 |
| Case 3 | Rx port: 0, 1, 2 | Rx port: 3, 4, 5 | Rx port: 6, 7, and (2 or 5) |
| | Tx port: 0, 1, 2 | Tx port: 0, 1, 2 | Tx port: 0, 1, 2 |

TABLE 5
3Tx being realized by 2 + 1 ports

| | SRS resource | SRS resource | |
|---|---|---|---|
| | pair 0: | pair 1: | SRS resource |
| | SRS resource | SRS resource | pair 2: |
| | 0_0 (2 ports), | 1_0 (2 ports), | SRS resource |
| | SRS resource | SRS resource | 2_0, (2 ports), SRS |
| | 0_1 (1 port) | 1_1 (1 port) | resource 2_1 (1 port) |
| Case 2 | Rx port: (0, 1), (2) | Rx port: (3, 4), (5) | Rx port: (6, 7), and |
| | Tx port: (0, 1), (2) | Tx port: (0, 1), (2) | one of (0~5) |
| | | | Tx port: (0, 1), (2) |
| Case 3 | Rx port: (0, 1), (2) | Rx port: (3, 4), (5) | Rx port: (6, 7), |
| | Tx port: (0, 1), (2) | Tx port: (0, 1), (2) | and (2 or 5) |
| | | | Tx port: 0, 1, 2 |

TABLE 6
3Tx being realized by 2 + 1 ports

| | SRS resource | SRS resource | |
|---|---|---|---|
| | pair 0: | pair 1: | |
| | SRS resource | SRS resource | |
| | 0_0 (2 ports), | 1_0 (2 ports), | |
| | SRS resource | SRS resource | SRS resource 2: SRS |
| | 0_1 (1 port) | 1_1 (1 port) | resource 2_0, (2 ports) |
| Case 1 | Rx port: (0, 1), (2) | Rx port: (3, 4), (5) | Rx port: (6, 7) |
| | Tx port: (0, 1), (2) | Tx port: (0, 1), (2) | Tx port: any two of |
| | | | (0, 1, 2) |

The above configurations can be for one traverse of 3 transmit ports for 3 (or 4, 6, 8) receive ports. The above configuration can correspond to a type of time domain behavior, e.g., periodic, semi-persistent, or aperiodic. More than one configuration can be configured to a UE, each configuration may correspond to a type of time domain behavior. E.g., up to one configuration associated with periodic, up to two configurations associated with semi-persistent, if the UE is not indicating srs-AntennaSwitching2SP-1Periodic.

### Embodiment 3: Power Control for SRS Transmission

A UE may be configured with one or more SRS resource sets, each SRS resource set including one or more SRS resources. The UE may receive SRI indicating one or more SRS resources for a PUSCH transmission.

The sum of the numbers (or counts) of ports of the one or more SRS resources is 3. For example, one SRS resource is configured with 2 ports, and another one SRS resource is configured with 1 port.

If the more than one SRS resource is transmitted during the same time, e.g., a same (OFDM) symbol, or a same slot, etc., the power for each port of SRS may be the same. E.g., ⅓ P_{T} for each port, where P_{T} is the required transmit power of the SRS transmission which is determined based on path loss, open-loop power control parameters, and/or closed-loop power control parameters, as shown in case 1 in Table 7.

If the more than one SRS resource is transmitted during different times, e.g., different (OFDM) symbols, or different slots, etc., it is possible to set power of each port in different times different. The imbalanced power among ports may impact network evaluation and may further impact performance of PUSCH. So the power for each port of SRS may be the same. The power for each port may be determined by the power of the SRS resource that is configured with a larger number (or count) of ports among the more than one SRS resource.

For example, SRS resource 0 is configured with 2 ports, SRS resource 1 is configured with 1 port, and the two SRS resources are transmitted in different symbols. One half of P_{T} is determined for each port for SRS resource 0, P_{T} is determined for each port for SRS resource 1. Accordingly, ½ P_{T} is determined as the transmit power for each port for both SRS resources, where P_{T} is the transmit power of the SRS transmission for the two SRS resources with a sum of 3 ports. That means the transmit power is assumed to be split among a number of ports in one symbol, ½ P_{T} for each of two ports (port 0, and port 1) that are configured in SRS resource 0, the one port (port 2) which is configured in SRS resource 1 can reach up to P_{T}, but port 2 can keep the same power level as the other ports, such as port 0 and 1; accordingly, the transmit power for port 2 may be reduced to ½ P_{T}, i.e., the same as for port 0 or port 1, as shown in case 2 in Table 7.

TABLE 7

| | Symbol n | Symbol n + 1 |
|---|---|---|
| Case 1 | SRS resource 0: port 0 and 1 | |
| | SRS resource 1: port 2 | |
| | Power: ⅓ P_{T} for | |
| | port 0, 1, or 2 | |
| Case 2 | SRS resource 0: port 0 and 1 | SRS resource 1: port 2 |
| | Power: ½ P_{T} for | Power: ½ P_{T} |
| | port 0, or 1 | for port 2 |

A similar issue may exist for SRS resources with different number of ports for antenna switching.

For example, for a 3T4R configuration, SRS resource 0 configured with 3 ports and SRS resource 1 configured with 1 port are within one SRS resource set for antenna switching, and SRS resource 0 and SRS resource 1 are transmitted in different symbols, the power for each port can be determined as the same, e.g., the minimum value among P0 and P1, where P0 is power calculated for each port in SRS resource 0 as ⅓ P_{T}, and P1 is power calculated for each port in SRS resource 1 as P_{T}; accordingly, the transmit power for each port of SRS resource 0 and SRS resource 1 is determined as the minimum value ⅓ P_{T}, as shown in case 1 in Table 8.

TABLE 8

| | Symbol n | Symbol n + 1 |
|---|---|---|
| Case 1 | SRS resource 0: | SRS resource 1: port 3 |
| | port 0, 1 and 2 | Power: P_{T} for port 3, further |
| | Power: ⅓ P_{T} for | reduced to ⅓ P_{T} to keep same |
| | port 0, 1, or 2 | power as port 0, 1, 2 |

As another example, for a 3T4R configuration, SRS resource 0 configured with 3 ports is realized by a pair of SRS resources, SRS resource 0_0 with 2 ports and SRS resource 0_1 with 1 port, and SRS resource 1 configured with 1 port are within one SRS resource set for antenna switching. SRS resource 0_0, SRS resource 0_1, and SRS resource 1 are transmitted in different symbols, the power for each port can be determined as the same, e.g., the minimum value among P0_0, P0_1, and P1, where P0_0 is power calculated for each port in SRS resource 0_0 as ½ P_{T}, P0_1 is power calculated for each port in SRS resource 0_1 as P_{T}, and P1 is power calculated for each port in SRS resource 1 as P_{T}; accordingly, the transmit power for each port of SRS resource 0_0, SRS resource 0_1 and SRS resource 1 is determined as the minimum value ½ P_{T}, as shown in case 1 in Table 9.

TABLE 9

| | Symbol n − 1 | Symbol n | Symbol n + 1 |
|---|---|---|---|
| Case | SRS resource | SRS resource | SRS resource 1: port 3 |
| 1 | 0_0: port | 0_1: port 2 | Power: P_{T} for port 3, |
| | 0, 1 | Power: P_{T} for port 2, | further reduced to ½ |
| | Power: ½ P_{T} | further reduced to ½ P_{T} | P_{T} to keep same power |
| | for port | to keep same power as | as port 0, 1, 2 |
| | 0, 1 | port 0, 1, 3 | |

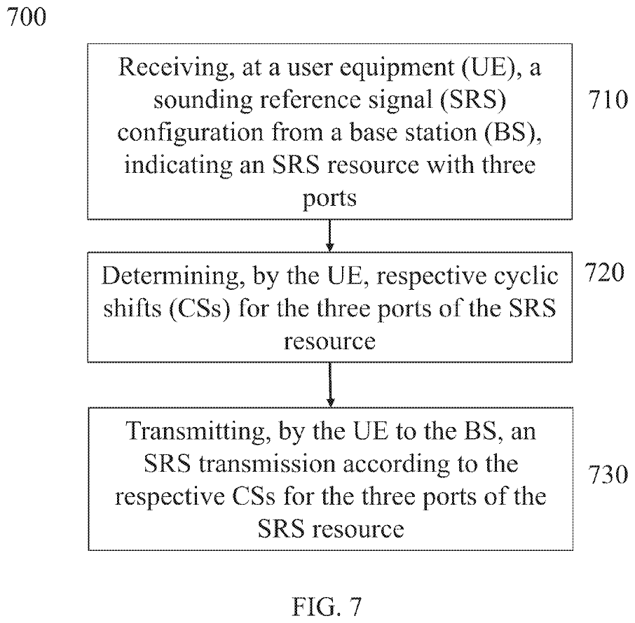

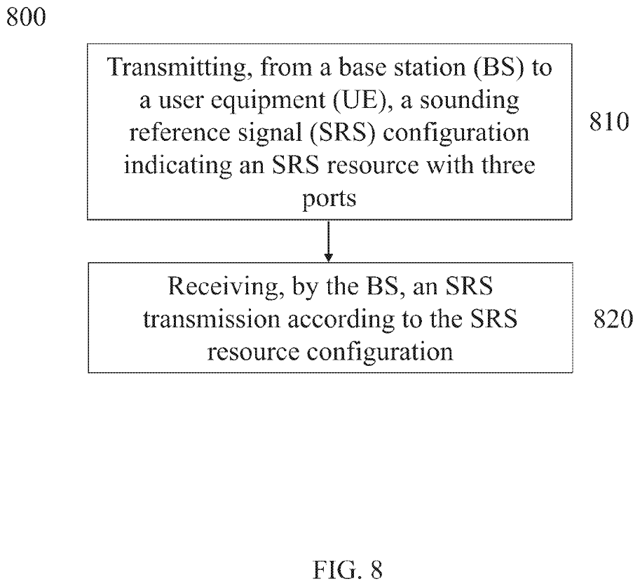

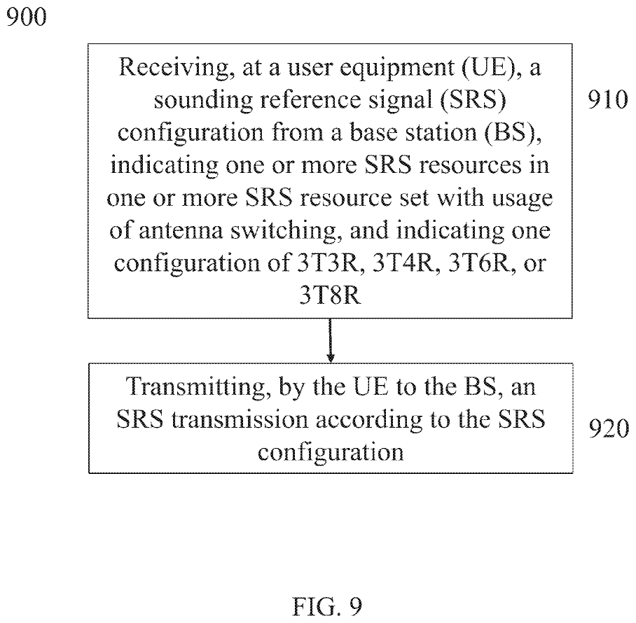

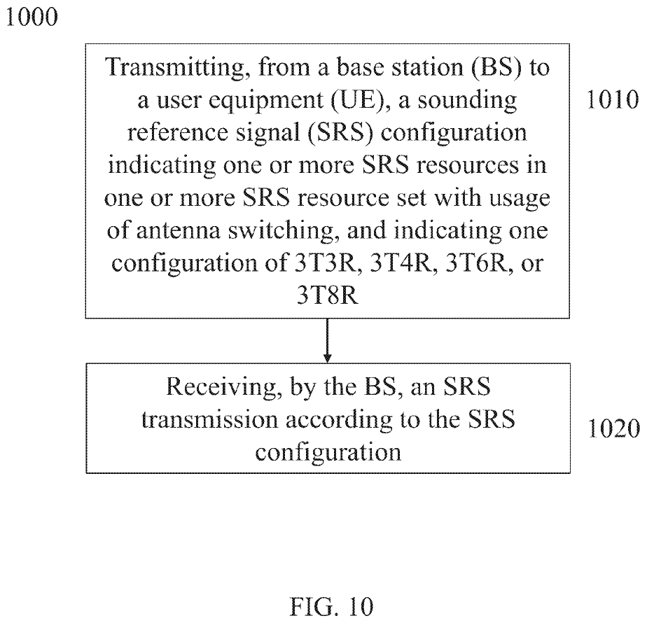

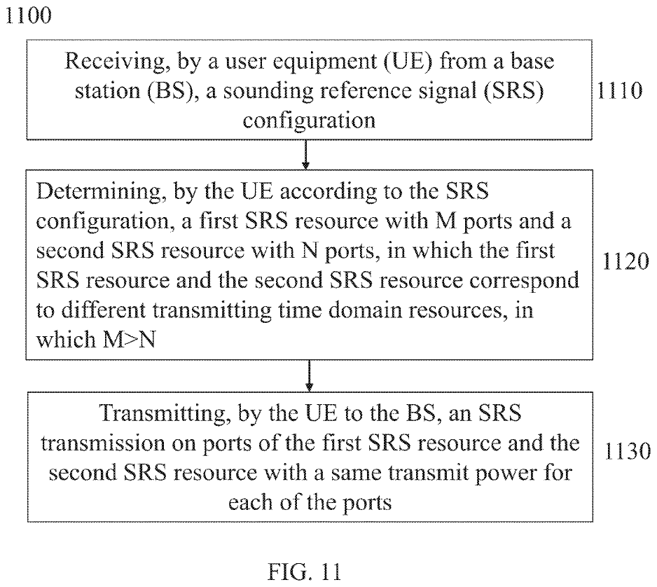

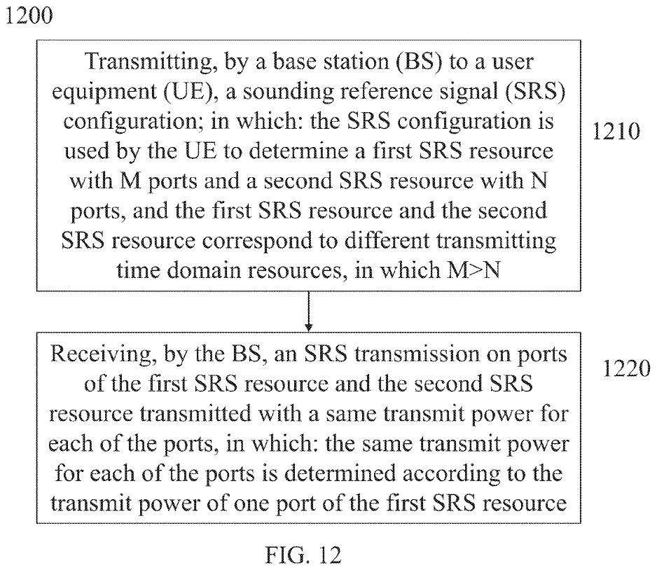

Some embodiments may implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station. The following listing of solutions may be implemented by some preferred embodiments.
1. A method (e.g., method 700 as illustrated in FIG. 7), including: receiving 710, at a user equipment (UE), a sounding reference signal (SRS) configuration from a base station (BS), indicating an SRS resource with three ports; determining 720, by the UE, respective cyclic shifts (CSs) for the three ports of the SRS resource; and transmitting 730, by the UE to the BS, an SRS transmission according to the respective CSs for the three ports of the SRS resource.
2. A method (e.g., method 800 as illustrated in FIG. 8), including: transmitting 810, from a base station (BS) to a user equipment (UE), a sounding reference signal (SRS) configuration indicating an SRS resource with three ports; and receiving 820, by the BS, an SRS transmission according to the SRS resource configuration.
3. The method of any one or more solutions disclosed herein, in which the respective CSs for the three ports of the SRS resource is determined according to a starting CS and one CS offset or two CS offsets.
4. The method of any one or more solutions disclosed herein, in which the one CS offset is determined by a number of candidate CSs divided by 3, or a round-up integer value of a number of candidate CSs divided by 3.
5. The method of any one or more solutions disclosed herein, (1) in which the one CS offset is determined by a number of candidate CSs divided by 3 if the number of candidate CSs is divisible by 3; or (2) in which the one CS offset is determined by a round-up to an integer value of a number of candidate CSs divided by 3 if the number of candidate CSs is not divisible by 3.
6. The method of any one or more solutions disclosed herein, (1) in which a number of candidate CSs is determined according to the SRS configuration; or (2) in which the starting CS is determined according to the SRS configuration.
7. The method of any one or more solutions disclosed herein, in which the three ports correspond to a same comb offset.
8. The method of any one or more solutions disclosed herein, in which the SRS resource with three ports includes one SRS resource configured with three ports, or more than one SRS resource which is configured with a sum of three ports.
9. A method (e.g., method 900 as illustrated in FIG. 9), including: receiving 910, at a user equipment (UE), a sounding reference signal (SRS) configuration from a base station (BS), indicating one or more SRS resources in one or more SRS resource set with usage of antenna switching, and indicating one configuration of 3T3R, 3T4R, 3T6R, or 3T8R; and transmitting 920, by the UE to the BS, an SRS transmission according to the SRS configuration.
10. A method (e.g., method 1000 as illustrated in FIG. 10), including: transmitting 1010, from a base station (BS) to a user equipment (UE), a sounding reference signal (SRS) configuration indicating one or more SRS resources in one or more SRS resource set with usage of antenna switching, and indicating one configuration of 3T3R, 3T4R, 3T6R, or 3T8R; and receiving 1020, by the BS, an SRS transmission according to the SRS configuration.
11. The method of any one or more solutions disclosed herein, in which: the configuration is 3T3R, and the UE is configured to transmit, via three transmitter ports, one SRS resource, wherein the one SRS resource belongs to one SRS resource set.
12. The method of any one or more solutions disclosed herein, in which: the configuration is 3T3R, and the UE is configured to transmit, via three transmitter ports, one SRS resource pair including a first SRS resource and a second SRS resource, the first SRS resource being configured with one transmitter port, and the second SRS resource being configured with two transmitter ports; wherein the first SRS resource and the second SRS resource belong to a same SRS resource set or belong to different SRS resource sets.
13. The method of any one or more solutions disclosed herein, (1) in which wherein the first SRS resource do not share any UE antenna ports with the second SRS resource; (2) in which the first SRS resource and the second SRS resource are configured to be transmitted in a same frequency domain resource; (3) in which the first SRS resource and the second SRS resource are configured to be transmitted in same symbols; (4) in which the first SRS resource and the second SRS resource are configured to be transmitted in different symbols; or (5) in which the first SRS resource and the second SRS resource are associated with a same spatial filter. In some embodiments, regarding the spatial domain resource, the first SRS resource and the second SRS resource can be configured with (or be assumed as) a same spatial filter, or associated with a same QCL (quasi-co-location) type D reference signal (RS).
14. The method of any one or more solutions disclosed herein, in which: the configuration is 3T4R, and the UE is configured to transmit, via three transmitter ports, two three-port SRS resources, wherein the two three-port SRS resources belong to a same SRS resource set, or belong to different SRS resource sets.
15. The method of any one or more solutions disclosed herein, in which the two three-port SRS resources are associated with a first group of UE antennas and a second group of UE antennas, respectively, the first group of UE antennas and the second group of UE antennas partially overlapping such that the first group of UE antennas and the second group of UE antennas collectively traverse four receiver ports of the 3T4R configuration.
16. The method of any one or more solutions disclosed herein, (1) in which the two three-port SRS resources are configured to be transmitted in different symbols or in different slots; or (2) in which the two three-port SRS resources are configured to be transmitted in a same frequency domain resource.
17. The method of any one or more solutions disclosed herein, in which: the configuration is 3T4R, and the UE is configured to transmit, via three transmitter ports, one three-port SRS resource and one one-port SRS resource; wherein the one three-port SRS resource and one one-port SRS resource belong to a same SRS resource set, or belong to different SRS resource sets.
18. The method of any one or more solutions disclosed herein, (1) in which one three-port SRS resource and one one-port SRS resource do not share any UE antenna ports; (2) in which the one three-port SRS resource and one one-port SRS resource are configured to be transmitted in different symbols or in different slots; or (3) in which the one three-port SRS resource and one one-port SRS resource are configured to be transmitted in a same frequency domain resource.
19. The method of any one or more solutions disclosed herein, in which: the configuration is 3T6R, and the UE is configured to transmit, via three transmitter ports, two three-port SRS resources, the two three-port SRS resources belonging to a same SRS resource set or belonging to different SRS resource sets.
20. The method of any one or more solutions disclosed herein, in which the two three-port SRS resources are associated with a first group of UE antennas and a second group of UE antennas, respectively, the first group of UE antennas and the second group of UE antennas being different such that the first group of UE antennas and the second group of UE antennas collectively traverse six receiver ports of the 3T6R configuration.
21. The method of any one or more solutions disclosed herein, (1) in which the two three-port SRS resources do not share any UE antenna ports; the two three-port SRS resources are configured to be transmitted in different symbols or in different slots; or (2) in which the two three-port SRS resources are configured to be transmitted in a same frequency domain resource.
22. The method of any one or more solutions disclosed herein, in which: the configuration is 3T8R, and the UE is configured to transmit, via three transmitter ports, three three-port SRS resources, the three three-port SRS resources belonging to a same SRS resource set or belonging to different SRS resource sets.
23. The method of any one or more solutions disclosed herein, in which the three three-port SRS resources are associated with a first group of UE antennas, a second group of UE antennas, and a third group of UE antennas, respectively, the first group of UE antennas, the second group of UE antennas, and the third group of UE antennas partially overlapping such that the first group of UE antennas, the second group of UE antennas, and the third group of UE antennas collectively traverse eight receiver ports of the 3T8R configuration.
24. The method of any one or more solutions disclosed herein, in which the three three-port SRS resources are configured to be transmitted in different symbols or in different slots; or wherein the three three-port SRS resources are configured to be transmitted in a same frequency domain resource.
25. The method of any one or more solutions disclosed herein, in which: the configuration is 3T8R, and the UE is configured to transmit, via three transmitter ports, two three-port SRS resources and one two-port SRS resource, the two three-port SRS resources and one two-port SRS resource belonging to a same SRS resource set or belonging to different SRS resource sets.
26. The method of any one or more solutions disclosed herein, (1) in which the two three-port SRS resources and one two-port SRS resource do not share any UE antenna ports; (2) in which the two three-port SRS resources and one two-port SRS resource are configured to be transmitted in different symbols or in different slots; or (3) in which the two three-port SRS resources and one two-port SRS resource are configured to be transmitted in a same frequency domain resource.
27. The method of any one or more solutions disclosed herein, in which any one of the three-port SRS resource includes an SRS resource pair that includes a first SRS resource and a second SRS resource, the first SRS resource being configured with one transmitter port and the second SRS resource being configured with two transmitter ports.
28. A method (e.g., method 1100 as illustrated in FIG. 11), including: receiving 1110, by a user equipment (UE) from a base station (BS), a sounding reference signal (SRS) configuration; determining 1120, by the UE according to the SRS configuration, a first SRS resource with M ports and a second SRS resource with N ports, in which the first SRS resource and the second SRS resource correspond to different transmitting time domain resources; and transmitting 1130, by the UE to the BS, an SRS transmission on ports of the first SRS resource and the second SRS resource with a same transmit power for each of the ports, in which: Nis a positive integer, and M is a positive integer that is greater than N.
29. A method (e.g., method 1200 as illustrated in FIG. 12), including: transmitting 1210, by a base station (BS) to a user equipment (UE), a sounding reference signal (SRS) configuration; in which: the SRS configuration is used by the UE to determine a first SRS resource with M ports and a second SRS resource with N ports, and the first SRS resource and the second SRS resource correspond to different transmitting time domain resources; and receiving 1220, by the BS, an SRS transmission on ports of the first SRS resource and the second SRS resource transmitted with a same transmit power for each of the ports, in which: Nis a positive integer, M is a positive integer that is greater than N, and the same transmit power for each of the ports is determined according to the transmit power of one port of the first SRS resource.
30. The method of any one or more solutions disclosed herein, in which the transmit power of one port of the first SRS resource is determined by evenly splitting a required transmit power over M ports.
31. The method of any one or more solutions disclosed herein, in which a sum of M and Nis 3.
32. The method of any one or more solutions disclosed herein, in which usage of the first SRS resource and a second SRS resource is codebook or antenna switching.
33. The method of any one or more solutions disclosed herein, in which a sum of M and Nis Y, and Y is a number of receiver antenna ports of the UE for usage of the first SRS resource and the second SRS resource in antenna switching. Note that the first SRS resource or the second SRS resource can be extended to more than one SRS resource, then M can be M0, M1, . . . , for the more than one SRS resource respectively corresponding to the first SRS resource, and N can be N0, N1, . . . , for the more than one SRS resource respectively corresponding to the second SRS resource, and sum of M and Nis Y can be extended to sum of M0, M1, . . . , and N0, N1, . . . , can be Y.
34. A wireless communication device, including: at least one processor configured to perform the method recited in any one or more of solutions 1-33.
35. One or more non-transitory computer-readable media storing computer-executable instructions that, when executed by one or more processors, cause the one or more processors to perform the method recited in any one or more of solutions 1-33.

It will be appreciated that the present document discloses techniques that can be embodied in various embodiments to allow a UE-triggered reporting of beam report information. Specifically, events for beam reporting are defined based on measurement quality variation monitoring among beams at different time instances/beam groups or for different channels/RSs. The beam reporting would be triggered if any of the pre-defined events occurs. As the event-triggered beam report is initiated by the UE on demand, the reporting latency and uplink reporting resource consumption can be greatly reduced compared with the conventional beam report method.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some implementations be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method, comprising:
receiving, at a user equipment (UE), a sounding reference signal (SRS) configuration from a base station (BS), indicating one or more SRS resources in one or more SRS resource set with usage of antenna switching, and indicating one configuration of 3T3R, 3T4R, 3T6R, or 3T8R, wherein:
in an event that the configuration is 3T6R, the UE is configured to transmit, via three transmitter ports, two three-port SRS resources, wherein the two three-port SRS resources belong to a same SRS resource set, or belong to different SRS resource sets,
and wherein the two three-port SRS resources are associated with a first group of UE (111, 112 and 113) antennas and a second group of UE antennas, respectively, the first group of UE antennas and the second group of UE antennas being different such that the first group of UE antennas and the second group of UE antennas collectively traverse six receiver ports of the 3T6R configuration; and
transmitting, by the UE to the BS, an SRS transmission according to the SRS configuration.

2. The method of claim 1, wherein:
the configuration is 3T3R, and
the UE is configured to transmit, via three transmitter ports, one SRS resource, wherein the one SRS resource belongs to one SRS resource set.

3. The method of claim 1, wherein:
the configuration is 3T4R, and
the UE is configured to transmit, via three transmitter ports, two three-port SRS resources, wherein the two three-port SRS resources belong to a same SRS resource set, or belong to different SRS resource sets.

4. The method of claim 3, wherein the two three-port SRS resources are associated with a first group of UE antennas and a second group of UE antennas, respectively, the first group of UE antennas and the second group of UE antennas partially overlapping such that the first group of UE antennas and the second group of UE antennas collectively traverse four receiver ports of the 3T4R configuration.

5. The method of claim 3,
wherein the two three-port SRS resources are configured to be transmitted in different symbols or in different slots; or
wherein the two three-port SRS resources are configured to be transmitted in a same frequency domain resource.

6. The method of claim 1, wherein:
the configuration is 3T4R, and
the UE is configured to transmit, via three transmitter ports, one three-port SRS resource and one one-port SRS resource; wherein the one three-port SRS resource and one one-port SRS resource belong to a same SRS resource set, or belong to different SRS resource sets.

7. The method of claim 6,
wherein one three-port SRS resource and one one-port SRS resource do not share any UE antenna ports;
wherein the one three-port SRS resource and one one-port SRS resource are configured to be transmitted in different symbols or in different slots; or
wherein the one three-port SRS resource and one one-port SRS resource are configured to be transmitted in a same frequency domain resource.

8. The method of claim 1,
wherein the two three-port SRS resources do not share any UE antenna ports; the two three-port SRS resources are configured to be transmitted in different symbols or in different slots; or
wherein the two three-port SRS resources are configured to be transmitted in a same frequency domain resource.

9. The method of claim 1, wherein:
the configuration is 3T8R, and
the UE is configured to transmit, via three transmitter ports, three three-port SRS resources; wherein the three three-port SRS resources belong to a same SRS resource set, or belong to different SRS resource sets.

10. The method of claim 9, wherein the three three-port SRS resources are associated with a first group of UE antennas, a second group of UE antennas, and a third group of UE antennas, respectively, the first group of UE antennas, the second group of UE antennas, and the third group of UE antennas partially overlapping such that the first group of UE antennas, the second group of UE antennas, and the third group of UE antennas collectively traverse eight receiver ports of the 3T8R configuration.

11. The method of claim 9, wherein the three three-port SRS resources are configured to be transmitted in different symbols or in different slots; or wherein the three three-port SRS resources are configured to be transmitted in a same frequency domain resource.

12. The method of claim 1, wherein:
the configuration is 3T8R, and
the UE is configured to transmit, via three transmitter ports, two three-port SRS resources and one two-port SRS resource; wherein the two three-port SRS resources and one two-port SRS resource belong to a same SRS resource set, or belong to different SRS resource sets.

13. The method of claim 12,
wherein the two three-port SRS resources and one two-port SRS resource do not share any UE antenna ports;
wherein the two three-port SRS resources and one two-port SRS resource are configured to be transmitted in different symbols or in different slots; or
wherein the two three-port SRS resources and one two-port SRS resource are configured to be transmitted in a same frequency domain resource.

14. A wireless communication device, comprising:
at least one processor; and
memory for storing computer-executable instructions that, when executed by the at least one processor, cause the device to:
receive a sounding reference signal (SRS) configuration from a base station (BS), indicating one or more SRS resources in one or more SRS resource set with usage of antenna switching, and indicating one configuration of 3T3R, 3T4R, 3T6R, or 3T8R, wherein:
in an event that the configuration is 3T6R, the wireless communication device is configured to transmit, via three transmitter ports, two three-port SRS resources, wherein the two three-port SRS resources belong to a same SRS resource set, or belong to different SRS resource sets,
and wherein the two three-port SRS resources are associated with a first group of user equipment (UE) antennas and a second group of UE antennas, respectively, the first group of UE antennas and the second group of UE antennas being different such that the first group of UE antennas and the second group of UE antennas collectively traverse six receiver ports of the 3T6R configuration; and
transmit, to the BS, an SRS transmission according to the SRS configuration.

15. A non-transitory computer-readable media storing computer-executable instructions that, when executed by one or more processors, cause the one or more processors to perform the method of claim 1.

16. A method, comprising:
transmitting, from a base station (BS) to a user equipment (UE), a sounding reference signal (SRS) configuration indicating one or more SRS resources in one or more SRS resource set with usage of antenna switching, and indicating one configuration of 3T3R, 3T4R, 3T6R, or 3T8R, wherein:
in an event that the configuration is 3T6R, the BS configures the UE (111, 112 and 113) to transmit, via three transmitter ports, two three-port SRS resources, wherein the two three-port SRS resources belong to a same SRS resource set, or belong to different SRS resource sets,
and wherein the two three-port SRS resources are associated with a first group of UE antennas and a second group of UE antennas, respectively, the first group of UE antennas and the second group of UE antennas being different such that the first group of UE antennas and the second group of UE antennas collectively traverse six receiver ports of the 3T6R configuration; and
receiving, by the BS, an SRS transmission according to the SRS configuration.

17. The method of claim 16, wherein:
the configuration is 3T3R, and
the BS configures the UE to transmit, via three transmitter ports, one SRS resource, wherein the one SRS resource belongs to one SRS resource set.

18. The method of claim 16,
wherein the two three-port SRS resources do not share any UE antenna ports; the two three-port SRS resources are configured to be transmitted in different symbols or in different slots; or
wherein the two three-port SRS resources are configured to be transmitted in a same frequency domain resource.

19. The method of claim 16, wherein:
the configuration is 3T4R, and
the UE is configured to transmit, via three transmitter ports, two three-port SRS resources, wherein the two three-port SRS resources belong to a same SRS resource set, or belong to different SRS resource sets.

20. A non-transitory computer-readable media storing computer-executable instructions that, when executed by one or more processors, cause the one or more processors to perform the method of claim 16.
